(19) United States
(12) Patent Application Publication
(10) Pub. No.: US 2007/0273615 A1
(43) Pub. Date: Nov. 29, 2007

(54) Method of Driving Plasma Display Panel

(76) Inventors: Hidehiko Shoji, Osaka (JP); Takahiko Origuchi, Osaka (JP)

Correspondence Address: MCDERMOTT WILL & EMERY LLP, 600 13TH STREET, NW, WASHINGTON, DC, 20005-3096, US

(21) Appl. No.: 11/661,394

(22) PCT Filed: Aug. 3, 2006
(86) PCT No.: PCT/JP06/15369

§ 371 Date: Feb. 28, 2007

(30) Foreign Application Priority Data
Aug. 3, 2005 (JP) 2005-224898

(51) Int. Cl. G09G 3/28

(52) U.S. Cl. 345/60

(57) ABSTRACT

A driving method of a plasma display panel with discharge cells formed at intersections of scanning electrodes SC1 through SCn and sustaining electrodes SU1 through SUn with data electrodes D1 through Dm includes setting a voltage applied to sustaining electrodes SU1 through SUn in a writing period of a sub-field whose brightness weight is lowest of a plurality of sub-fields to be higher than a voltage applied to sustaining electrodes SU1 through SUn in a writing period of other sub-fields, and, when whether each of the sub-fields emit or not emit light is controlled to display a desired gradation at a discharge cell, letting a discharge cell that displays a gradation higher than a first threshold value emit even in a sub-field whose brightness weight is lowest.

### TECHNICAL FIELD

The present invention relates to a method of driving a plasma display panel that is used in a display device.

### BACKGROUND ART

An AC surface discharge panel typical in a plasma display panel (hereinafter, abbreviated as “panel”) has many discharge cells formed between a front plate and a back plate disposed facing to each other. In the front plate, a plurality of display electrodes made of a pair of a scanning electrode and a sustaining electrode are formed in parallel with each other on a front glass plate and a dielectric layer and a protective layer are formed so as to cover the display electrodes. In the back plate, on a back glass plate, a plurality of parallel data electrodes, a dielectric layer that covers the data electrodes and a plurality of separating walls in parallel with the data electrodes on the dielectric layer are formed respectively, and on a surface of the dielectric layer and side faces of the separating walls a phosphor layer is formed. The front plate and back plate, with the display electrodes and the data electrodes disposed faced to each other so as to three-dimensionally intersect, are sealed and in a discharge space inside thereof a discharge gas is encapsulated. Here, at a portion where the display electrodes and the data electrode face each other, a discharge cell is formed. In a panel having such a configuration, in individual discharge cells, UV-rays are generated owing to the gas discharge, and, the UV-rays excite phosphors of the respective colors of red, green and blue to emit light to perform color display.

As a method of driving a panel, a sub-field method is used. In the sub-field method, one field period is divided into a plurality of sub-fields, and in the individual sub-fields the respective discharge cells are controlled so as to emit light or not to perform the gradation display. Individual sub-fields have an initializing period, a writing period and a sustaining period. In the initializing period, a discharge cell performs initializing discharge to form wall charges necessary for a subsequent writing operation. In addition, priming particles (detonating agent for discharge=excited particles) for making a discharge delay smaller to stably generate the writing discharge are generated. During the writing period, while a scanning pulse is sequentially applied to the scanning electrodes, a writing pulse corresponding to an image signal to be displayed is applied to the data electrode to selectively cause the writing discharge between the scanning electrode and the data electrode to selectively form wall discharge. In the subsequent sustaining period, a sustaining pulse is applied a predetermined number of times corresponding to the display brightness to be emitted between the scanning electrode and the sustaining electrode to selectively discharge the discharge cell where the wall charges were formed owing to the writing discharge to emit light. A rate of display brightness for each of sub-fields is hereinafter called as “brightness weight”.

Among such sub-field methods, in order to reduce emission that is not directly associated with the gradation display as far as possible to improve the contrast ratio, novel driving methods such as a carrying out initializing discharge with a gradually-varying voltage waveform and a selectively carrying out method where the initializing discharge to discharge cells to which sustaining discharge was applied are disclosed in Japanese Unexamined Patent Application Publication No. 2000-242224.

However, when the emission of the initializing discharge that is not associated with the gradation display is reduced, the priming effect tends to be weaker. Accordingly, when low gradation is displayed, there is a problem in that even when the writing pulse is applied, discharge cells that do not emit light (hereinafter, referred to as off-cell) are likely to be generated. In particular, when, like a sub-field subjected to an error-diffusion process, there is no discharge cell to emit light in the periphery and the discharge cell to emit light is isolated, there is a problem in that off-cells are likely to be generated.

### DISCLOSURE OF THE INVENTION

The driving method of a panel according to the invention is a method of driving a panel where a discharge cell is formed at an intersection of a scanning electrode and a sustaining electrode with a data electrode, one field period being constituted of a plurality of sub-fields each having a writing period and a sustaining period. In the writing period, writing discharge is selectively caused at the discharge cell. In the sustaining period, the sustaining discharge that lets the discharge cell where the writing discharge was generated emit light with a predetermined brightness weight is generated. In the writing period of the sub-field whose brightness weight is lowest of the plurality of sub-fields, a voltage applied to the sustaining electrode is set higher than a voltage applied to the sustaining electrode during the writing periods of other sub-fields to control whether light is emitted or not in the individual sub-fields to let the discharge cell display at a desired gradation. At this time, a first threshold value of the predetermined gradation and gradations of the respective discharge cells are compared. Thereby, the discharge cell that lets a gradation higher than the first threshold value display is controlled so as to emit light even in a sub-field whose brightness weight is lowest.

According to such a method of driving a panel, even when a low gradation is displayed, an off-cell is not likely to occur, so that a panel driving method excellent in image display quality can be provided.

### BRIEF DESCRIPTION OF THE DRAWINGS

FIG. 1 is a perspective view showing an essential part of a panel that uses a driving method in an embodiment of the invention.

FIG. 2 is an electrode arrangement diagram of a panel that uses a driving method in an embodiment of the invention.

FIG. 3 is a circuit block diagram of a plasma display device that uses a driving method in an embodiment of the invention.

FIG. 4 is a diagram showing driving voltage waveforms applied to the respective electrodes of a panel that uses a driving method in an embodiment of the invention.

FIG. 5A is a diagram showing gradations from 0 to 33 displayable by a driving method in an embodiment of the invention and codings thereof.

FIG. 5B is a diagram showing gradations from 35 to 256 displayable by a driving method in an embodiment of the invention and codings thereof.

FIG. 6A is a diagram showing gradations from 0 to 134 displayable by a driving method in an embodiment of the invention and codings thereof.

FIG. 6B is a diagram showing gradations from 139 to 256 displayable by a driving method in an embodiment of the invention and codings thereof.

### DESCRIPTION OF REFERENCE NUMERALS AND SIGNS

1: panel
2: front substrate
3: back substrate
4: scanning electrode
5: sustaining electrode
9: data electrode
12: data electrode driving circuit
13: scanning electrode driving circuit
14: sustaining electrode driving circuit
15: timing generator
18: image signal processor

### DESCRIPTION OF PREFERRED EMBODIMENTS

Now, a driving method of a panel in one embodiment of the invention will be described with reference to the drawings.

### Embodiments

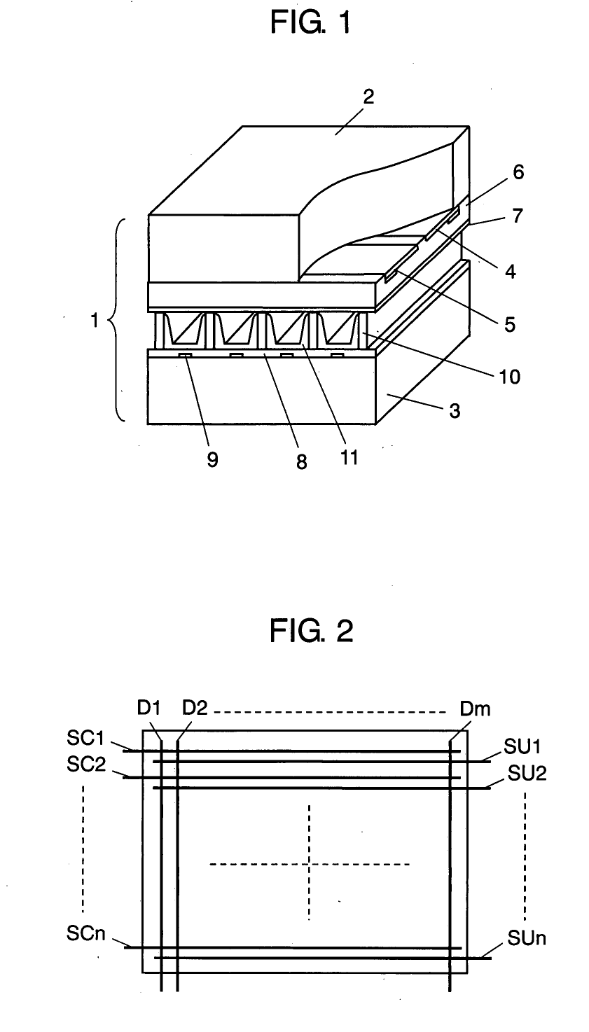

FIG. 1 is a perspective view showing an essential part of a panel that uses a driving method in an embodiment of the invention. In panel 1, glass front substrate 2 and glass back substrate 3 are disposed faced to each other and a discharge space is formed therebetween. On front substrate 2, with scanning electrode 4 and sustaining electrode 5 disposed in parallel to each other to form a pair, a plurality of pairs thereof are formed. Dielectric layer 6 is formed so as to cover scanning electrode 4 and sustaining electrode 5 and protective layer 7 is formed on dielectric layer 6. Furthermore, on back substrate 3, a plurality of data electrodes 9 covered with insulating layer 8 are disposed and further on insulating layer 8 separating wall 10 is disposed in parallel with data electrode 9. Still furthermore, on a surface of insulating layer 8 and a side face of separating wall 10, phosphor layer 11 is disposed. In a direction where scanning electrode 4 and sustaining electrode 5 intersect with data electrode 9, front substrate 2 and back substrate 3 are oppositely disposed, and, in a discharge space formed therebetween, as a discharge gas, for instance, a mixture gas of neon and xenon is encapsulated. The structure of the panel is not restricted to the above-mentioned one. For instance, one having a curb-like separating wall may be used as well.

FIG. 2 is an electrode arrangement diagram of a panel that uses a driving method in an embodiment of the invention. In a row direction, n scanning electrodes SC1 through SCn (scanning electrode 4 in FIG. 1) and n sustaining electrodes SU1 through SUn (sustaining electrode 5 in FIG. 1) are arranged and in a column direction m data electrodes D1 through Dm (data electrode 9 in FIG. 1) are arranged. At a portion where a pair of scanning electrode SCi (i=1 through n) and sustaining electrode SUi (i=1 through n) intersects with data electrode Dj (j=1 through m), a discharge cell is formed and the discharge cell is formed by m×n in the discharge space.

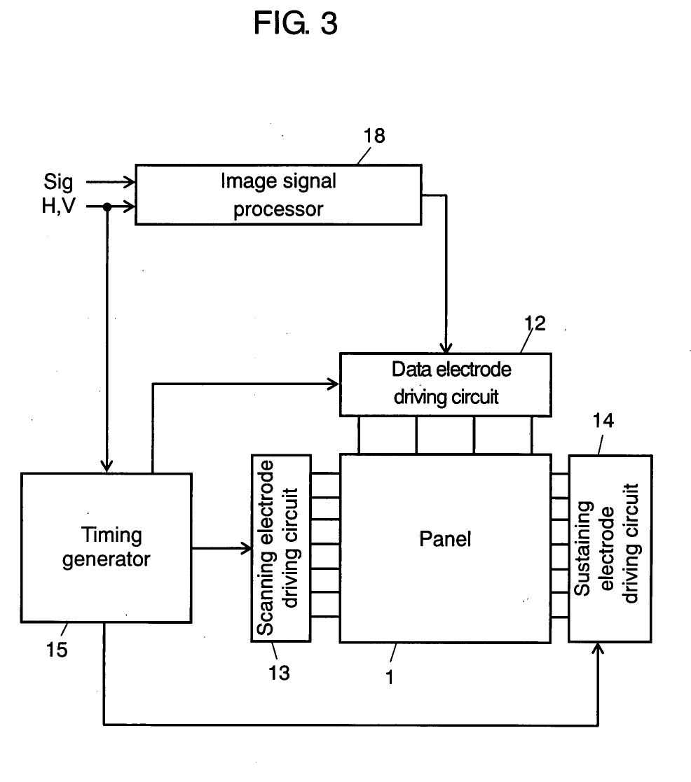

FIG. 3 is a circuit block diagram of a plasma display device that uses a driving method in an embodiment of the invention. The plasma display device includes panel 1, data electrode driving circuit 12, scanning electrode driving circuit 13, sustaining electrode driving circuit 14, timing generator 15, image signal processor 18 and a power source (not shown in the drawing). Image signal processor 18 converts image signal sig into image data in accordance with the number of pixels of panel 1 and divides the image data of the respective pixels into a plurality of bits corresponding to a plurality of sub-fields to output to data electrode driving circuit 12. Data electrode driving circuit 12 converts the image data for every sub-field into signals corresponding to the respective data electrodes D1 through Dm to drive the respective data electrodes D1 through Dm. Timing generator 15 generates timing signals based on horizontal synchronizing signal H and vertical synchronizing signal V and supplies to the respective driving circuit blocks. Scanning electrode driving circuit 13 supplies driving waveforms based on the timing signals to scanning electrodes SC1 through SCn and sustaining electrode driving circuit 14 supplies driving waveforms based on the timing signals to sustaining electrodes SU1 through SUn.

In the next place, a driving voltage waveform for driving a panel and an operation thereof will be described. In the embodiment, a description will be given with one field divided into 10 sub-fields (first SF, second SF, . . . , tenth SF) and the respective sub-fields weighted with brightness weights of (1, 2, 3, 6, 11, 18, 30, 44, 60, 81). In the embodiment like this, the brightness weights of the respective sub-fields are set so that the brightness weight of each of the sub-fields may not be larger than that of sub-fields after that. A sub-field whose display brightness is lowest is the first SF.

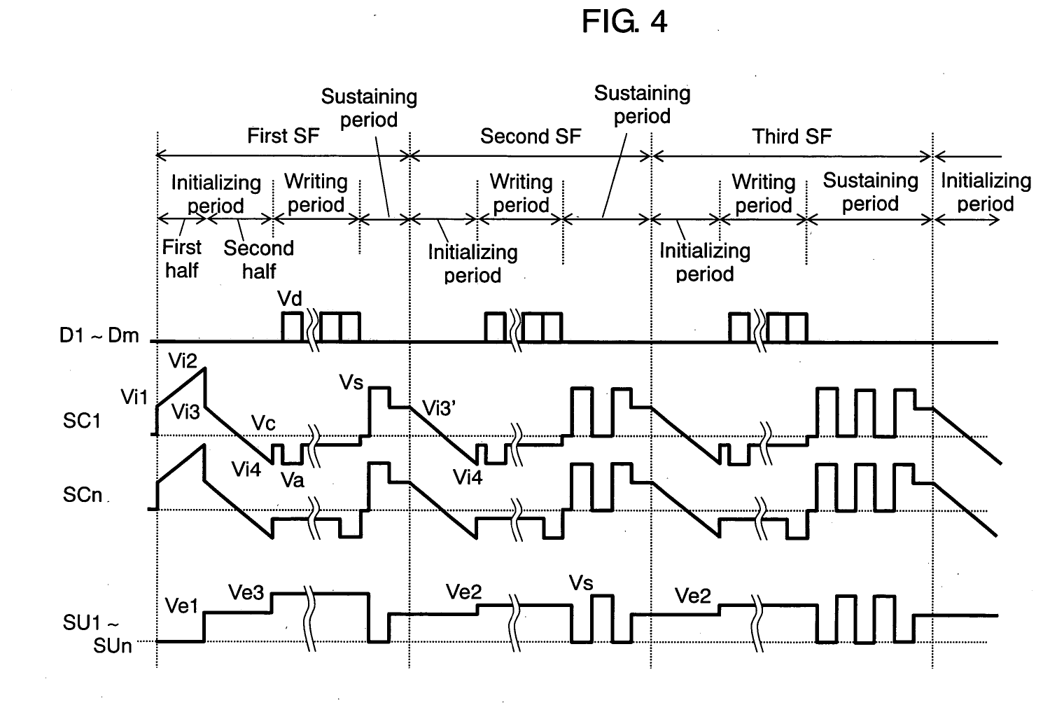

FIG. 4 is a diagram showing driving voltage waveforms applied to the respective electrodes of a panel that uses a driving method in an embodiment of the invention.

In the first half of the initializing period of the first SF lowest in the display brightness, data electrodes D1 through Dm and sustaining electrodes SU1 through SUn are maintained at 0V, and to scanning electrodes SC through SCn, a lamp voltage that gradually goes up from voltage Vi1 that is a discharge start voltage or less to voltage Vi2 that exceeds the discharge start voltage is applied. Then, in all discharge cells, a first weak initializing discharge is caused, and thereby, a negative wall voltage is stored on scanning electrodes SC1 through SCn and a positive wall voltage is stored on sustaining electrodes SU1 through SUn and data electrodes D1 through Dm. The wall voltage on the electrode here means a voltage generated owing to wall charges stored on the dielectric layer that covers the electrode and on the phosphor layer.

In the subsequent second half of the initializing period, with sustaining electrodes SU1 through SUn held at positive voltage Ve1, a lamp voltage that gradually goes down from voltage Vi3 to voltage Vi4 is applied to scanning electrodes SC1 through SCn. Then, in all discharge cells, a second weak initialization discharge is caused and the wall voltages on scanning electrodes SC1 through SCn and the wall voltages on sustaining electrodes SU1 through SUn are weakened, and thereby the wall voltages on data electrodes D1 through Dm are controlled to values appropriate for the writing operation.

In the embodiment, voltages Vi1, Vi2, Vi3, Vi4 and Ve1, respectively, are set at 180V, 320V, 180V, −120V and 150V. The voltage values are desirably optimized based on the discharge characteristics of the discharge cell.

During the writing period of the first SF lowest in the display brightness, voltage Ve3 is applied to sustaining electrodes SU1 through SUn and scanning electrodes SC1 through SCn are once held at voltage Vc. In the next place, positive writing pulse voltage Vd is applied to data electrode Dk (k=1 through m) of the discharge cell to be emitted in the first line of data electrodes D1 through Dm and to scanning electrode SC1 in the first line negative scanning pulse voltage Va is applied. Then, a voltage of the intersection of data electrode Dk with scanning electrode SC1 becomes one obtained by adding a wall voltage on the data electrode Dk and a wall voltage on the scanning electrode SC1 to an externally applied voltage (Vd−Va) to exceed a discharge start voltage. Then, writing discharge occurs between data electrode Dk and scanning electrode SC1 and between sustaining electrode SU1 and scanning electrode SC1, thereby on scanning electrode SC1 of the discharge cell a positive wall voltage is stored, on sustaining electrode SU1 a negative wall voltage is stored, and on data electrode Dk as well a negative voltage is stored. Thus, a writing operation where, in the discharge cell to be emitted in the first line, the writing discharge is caused to store the wall voltage on the respective electrodes is carried out. On the other hand, a voltage of an intersection of data electrode Dh (h≠k) to which writing pulse voltage Vd was not applied with scanning electrode SC1 does not exceed the discharge start voltage; accordingly, the writing discharge is not caused. The foregoing writing operation is sequentially carried out up to a discharge cell of the nth line, and thereby the writing period ends.

In the embodiment, voltages Ve3, Vc, Vd and Va, respectively, are set at 160V, 20V, 70V and −120V. The voltage values as well are desirably optimized based on the discharge characteristics of the discharge cell.

A remarkable point here is in that a value of voltage Ve3 is set higher than voltage Ve1 by about 10V, in particular, a value of voltage Ve3 is set higher than voltage Ve2 described later, that is, a value of a voltage that is applied to sustaining electrodes SU1 through SUn during the writing period of sub-fields that are not lowest in display brightness is. In the embodiment, voltage Ve3 is set higher than voltage Ve2 by about 5V.

In the subsequent sustaining period, sustaining electrodes SU1 through SUn are returned to 0V, and to scanning electrodes SC1 through SCn, first sustaining pulse Vs of the sustaining period is applied. In the discharge cell where the writing discharge was caused at this time, a voltage between on scanning electrode SCi and on sustaining electrode SUi becomes one obtained by adding a magnitude of the wall voltage on scanning electrode SCi and on sustaining electrode SUi to sustaining pulse voltage Vs and exceeds the discharge start voltage. Then, the sustaining discharge occurs between scanning electrode SCi and sustaining electrode SUi to emit light. At that time, a negative wall voltage is stored on scanning electrode SCi, a positive wall voltage is stored on sustaining electrode SUi, and a positive wall voltage is stored on data electrode Dk. In the discharge cells where the writing discharge was not caused in the writing period, the sustaining discharge is not caused and a wall voltage state at the end of the initializing period is maintained.

In FIG. 4, only one sustaining pulse is applied during the sustaining period of the first SF. However, as needs arise, a plurality of sustaining pulses may be applied. At that time, scanning electrodes SC through SCn are subsequently, returned to 0V and second sustaining pulse voltage Vs is applied to scanning electrodes SC1 through SCn. Then, in the discharge cell where the sustaining discharge was caused, a voltage between on sustaining electrode SUi and on scanning electrode SCi exceeds the discharge start voltage so that the sustaining discharge once more occurs between sustaining electrode SUi and scanning electrode SC1, and thereby on the sustaining electrode SUi a negative wall voltage is stored and on scanning electrode SCi a positive wall voltage is stored. Similarly thereafter, to scanning electrodes SC1 through SCn and sustaining electrodes SUi through SUn, the sustaining pulses of necessary number are applied, and thereby in the discharge cells where the writing discharge was caused during the sustaining period, the sustaining discharge is continually carried out. Thus, the sustaining operation during the sustaining period comes to completion.

In the embodiment, voltage Vs is set at 180V. The voltage value as well is desirably optimized based on the discharge characteristics of the discharge cell.

In the initializing period of a second SF, with sustaining electrodes SU1 through SUn held at voltage Ve1 and with data electrodes D1 through Dm held at a ground potential, a lamp voltage that gradually goes down from voltage Vi3′ toward voltage Vi4 is applied to scanning electrodes SC1 through SCn. Then, in the discharge cell in which the sustaining discharge was caused during a sustaining period of the previous sub-field, a weak initialization discharge is caused, wall voltages on scanning electrode SCi and Sustaining electrode SUi are weakened, and a wall voltage on data electrode Dk is as well controlled to a value appropriate for the writing operation. On the other hand, the discharge cell where the writing discharge and the sustaining discharge were not caused in the previous sub-field, the discharge is not caused, that is, a wall charge state at the time of completion of the initializing period of the previous sub-field is maintained. In the embodiment, the initialization operation of the second SF was described as a selective initialization. However, it may be an all-cell initialization operation.

In the writing period of the second SF, voltage Ve2 is applied to sustaining electrodes SU1 through SUn and scanning electrodes SC1 through SCn are held once at voltage Vc. As mentioned above, a voltage value of voltage Ve2 applied here is set lower than voltage Ve3. In the embodiment, voltage Ve2 is set lower than voltage Ve3 by about 5V.

Other voltages than that that is applied to sustaining electrodes SU1 through SUn are similar to the first SF. That is, writing pulse voltage Vd is applied to data electrode Dk (k=1 through m) of the discharge cell to be emitted in the first line of data electrodes D1 through Dm and scanning pulse voltage Va is applied to scanning electrode SC1 of the first line. Then, a writing operation where the writing discharge is caused in the discharge cell to be displayed in the first line to store a wall voltage on the respective electrodes is carried out. The foregoing writing operation is sequentially carried out to a discharge cell of the nth line and thereby the writing period comes to completion.

As to the subsequent sustaining periods, since except for the number of sustaining pulses the operation is similar to that of the sustaining period of the first SF, explanation thereof is omitted.

In the subsequent third SF through tenth SF as well, the initializing period is similar to the initializing period of the first SF or second SF, during the writing period, similarly to the second SF, voltage Ve2 is applied to sustaining electrodes SU1 through SUn to carry out the writing operation and, during the sustaining period, except for the number of the sustaining. pulses, the sustaining operation is carried out similarly to the sustaining period of the first SF.

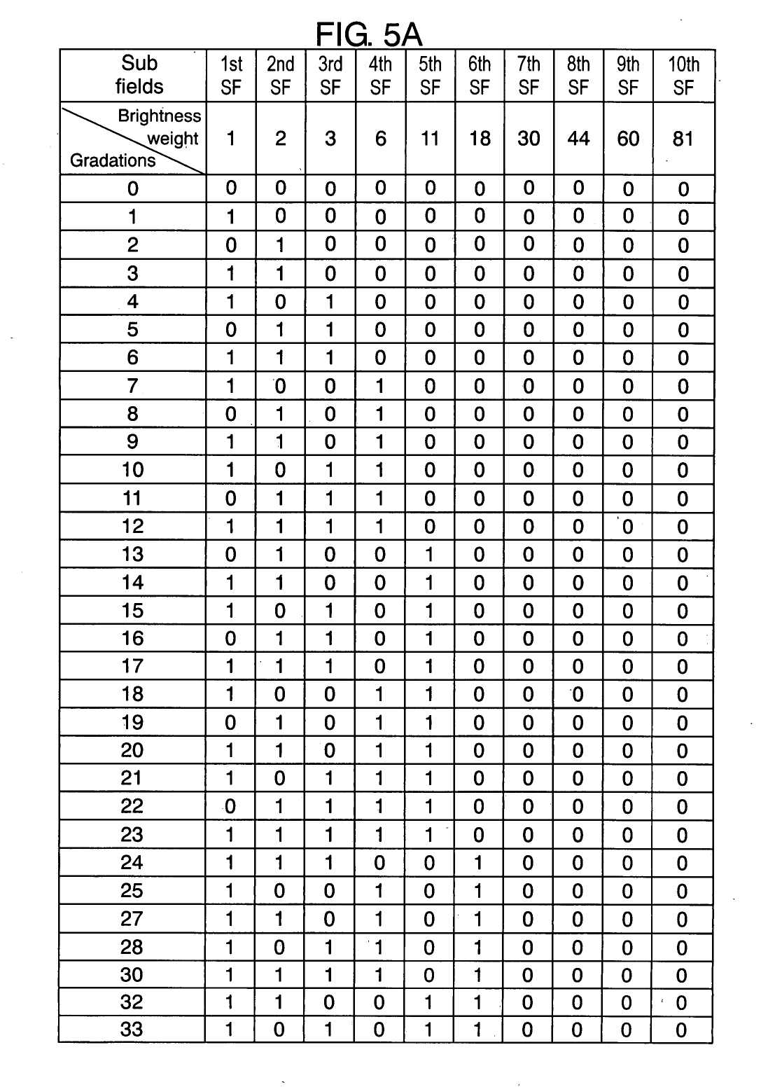

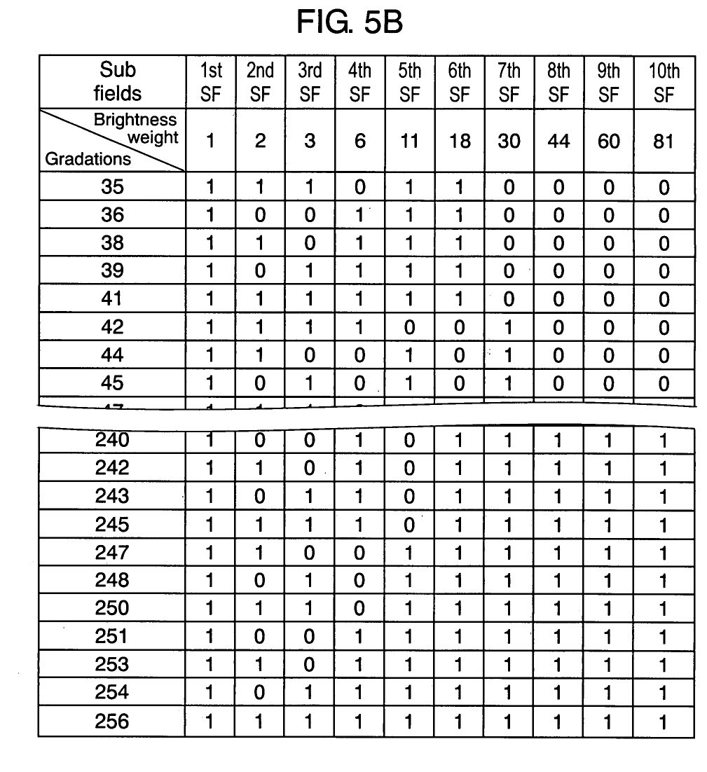

In the next place, the relationship showing in which sub-field the discharge cell is emitted to display a certain gradation (hereinafter, abbreviated as coding) will be described. FIG. 5 is a diagram showing the gradations used in the display of a driving method in the embodiment of the invention and codings thereof. For instance, in order to display the gradation [0], no discharge cells are allowed emitting in any sub-fields, and, in order to display the gradation [1], a discharge cell is allowed emitting only in the first SF. When the gradation [3] is displayed, there are a method where in the first SF and the second SF, the discharge cells are allowed emitting and a method where only the third SF is allowed emitting. When a plurality of codings are possible like in the case, the coding where a sub-field whose brightness weight is as small as possible is turned on is selected. That is, in the case of the gradation [3] being displayed, the discharge cells are allowed emitting in the first SF and the second SF.

The feature of the coding in the embodiment is in that, when whether individual sub-fields are emitted or not emitted is controlled to display a desired gradation in a discharge cell, a first threshold value of a predetermined gradation and a gradation of each of the discharge cells are compared, and a discharge cell that displays a gradation higher than the first threshold value is controlled so as to emit light even in a sub-field lowest in the brightness weight. Specifically, to a discharge cell that displays a gradation of [24] or more as the first threshold value, the first SF is controlled so as to necessarily emit light. In other words, a discharge cell that displays a gradation that has to be emit light in any one of the sixth SF through tenth SF, is controlled so as to emit light even in the first SF. The gradations that do not satisfy the requirement, that is, gradations [26], [29], [31], . . . , [255] are not used to display in the embodiment.

In the next place, a reason why voltage Ve3 that is applied to the sustaining electrode in the writing period of the first SF lowest in the display brightness is set higher than voltage Ve2 that is applied to the sustaining electrodes in the writing period of the subsequent sub-fields will be described.

As mentioned above, the brightness weights of the respective sub-fields are set so as not to be larger than the brightness weight of a sub-field disposed after the sub-field. That is, in the embodiment, the brightness weight of the sub-field disposed later is set larger. Here, the first SF, being [1] in the brightness weight, that is, being lowest in the display brightness, takes charge of a portion smallest in gradation difference. Accordingly, there is tendency in that discharge cells to emit light (hereinafter, abbreviated as “on-cell”) and discharge cells not to emit light (hereinafter, abbreviated as “off-cell”) mingle at random. In such a case, the on-cell is likely to be an on-cell whose adjacent discharge cells are the off-cells (hereinafter, abbreviated as “isolated on-cell”). Furthermore, when an error diffusion or dither diffusion process is applied, the on-cells and off-cells in the first SF mingle at random or regularly; accordingly, the probability of the on-cell becoming the isolated on-cell becomes higher.

When the isolated on-cell performs a writing operation, since there is no on-cell to which the writing operation was carried out immediately before in the proximity thereof, the priming accompanying the writing discharge cannot be obtained from adjacent discharge cells. Accordingly, in an existing driving method, since the isolated on-cell becomes large in the discharge delay and the wall voltage stored in the writing discharge becomes insufficient, in some cases, during the subsequent sustaining period, the sustaining discharge is not caused or the writing discharge itself is not caused to be an off-cell.

However, in the embodiment, since voltage Ve3 applied to the sustaining electrode during the writing period of the first SF is set high, the writing discharge tends to occur and, even in the isolated on-cell, the writing discharge can be assuredly caused to suppress the off-cell from occurring.

Of course, there is a problem in that, when voltage Ve3 applied to the sustaining electrode is set high, the writing discharge tends to occur, and thereby a discharge cell that should not emit light causes the writing discharge to increase a discharge cell that emits light during the sustaining period (hereinafter, abbreviated as “fault on-cell”). However, as a result of the inventors' detailed study, it was clarified that such a fault on-cell is caused only in an on-cell whose priming is excessive. Specifically, a discharge cell that emitted light in the tenth SF is likely to be a fault on-cell in the first SF, a discharge cell that emitted light in the ninth SF and did not emit light in the tenth SF becomes low in the probability of becoming a fault on-cell in the first SF, a discharge cell that emitted light in the eighth SF and did not emit light in the ninth and tenth SFs is largely reduced in the probability of becoming a fault on-cell in the first SF and a discharge cell that emitted light in the fifth SF and did not emit light in the sixth through tenth SFs does not become a fault on-cell in the first SF.

With that, in the embodiment, as shown in FIG. 5, a coding where a discharge cell that emitted light in any one of the sixth through tenth SFs emits light as well in the first SF is used. Accordingly, since discharge cells that display the gradations [0] through [23] do not emit light in the sixth through tenth SFs, in the first SF, the fault on-cell is not caused and discharge cells that display the gradations [24] through [255] are caused to emit light in any one of the sixth through tenth SFs. However, since the first SF necessarily emits light as well, in the first SF, a fault on-cell is not caused. In the embodiment like this, to a discharge cell that displays a gradation that has to be emitted in any one of the sixth through tenth SFs, the first SF is controlled so as to emit light as well, even when voltage Ve3 applied to the sustaining electrode is set high, the fault on-cell is not caused.

Of course, as mentioned above, gradations that are not displayed in the embodiment are caused. These are generated in a region that displays a gradation of [24] or more, that is, in a region that displays an image whose brightness is relatively high. On the other hand, the brightness that a person can feel, as known well, is logarithmic to the brightness. Accordingly, in a region that displays high brightness, even when a gradation that is not displayed is substituted by a gradation that can be displayed to resultantly cause a slight variation in the brightness, there is hardly conceived of unpleasant sensation. Alternatively, as needs arise, with gradations that can be displayed, the error diffusion or dither diffusion process may be applied to interpolate a gradation that is not displayed.

When an image display is performed with such a coding, the fault on-cell can be inhibited from occurring. In addition to this, a power of data electrode driving circuit 12 can be reduced. As mentioned above, data electrode driving circuit 12 converts image data for every sub-field into signals corresponding to the respective data electrodes D1 through Dm to drive the respective data electrodes D1 through Dm. When seen from data electrode driving circuit 12 side, each of data electrodes Dj is a capacitive load having composite capacitance with adjacent data electrodes Dj−1 and Dj+1, scanning electrodes SC1 through SCn and sustaining electrodes SU1 through SUn. Accordingly, during the writing period, every time when a voltage applied to each of the data electrodes is switched from a ground potential 0V to writing pulse voltage Vd or from writing pulse voltage Vd to the ground potential 0V, the capacitance has to be charged or discharged. However, in the embodiment, to a discharge cell that displays an image relatively high in the brightness, the first SF is controlled so as to emit light as well. Accordingly, a voltage applied to a corresponding data electrode is fixed to writing pulse voltage Vd in the first SF. As a result, a charge and discharge current can be reduced correspondingly and thereby the power consumption can be reduced.

In the embodiment, the coding where with a gradation that has to be emitted in any one of the sixth SF through tenth SF as a first threshold value, to discharge cells that display gradations higher than the first threshold value, emitting is performed in the first SF as well, is used. However, in addition to this, when the coding where with a gradation that has to be emitted in any one of the seventh SF through tenth SF as a second threshold value, to discharge cells that display gradations higher than the second threshold value, emitting is performed in the second SF, is used, power reduction effect can be further enlarged. Furthermore, when the coding where to a discharge cell that displays a gradation that is emitted in a sub-field larger in the brightness weight, in accordance with the brightness weights, emitting is performed in the third SF and so on is used, the power consumption reduction effect can be further enlarged.

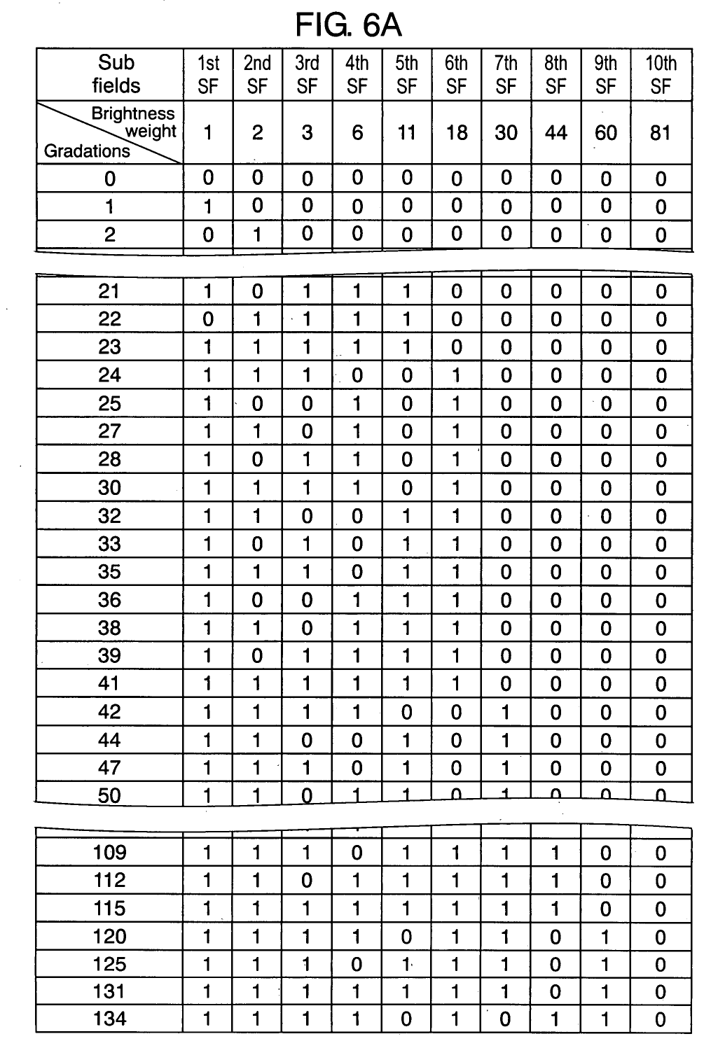

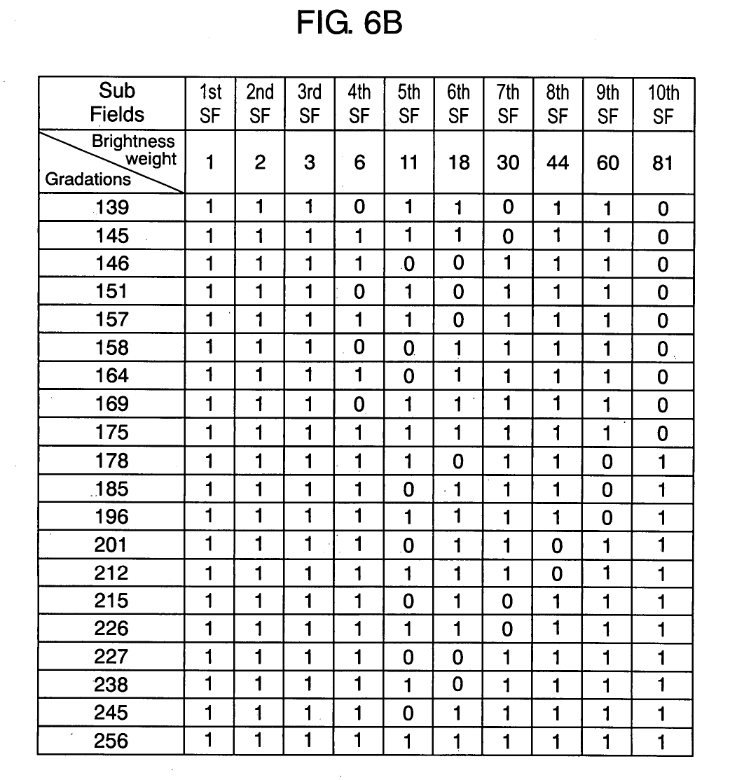

FIG. 6 is a diagram showing gradations that are used to display a driving method in the other embodiment of the invention and codings thereof. In the drawing, a coding where emitting is performed in the first SF to a discharge cell that displays a gradation that has to be emitted in any one of the sixth SF through tenth SF, emitting is performed in the first and second SFs to a discharge cell that displays a gradation that has to be emitted in any one of the seventh through tenth SFs, emitting is performed in the first through third SFs to a discharge cell that displays a gradation that has to be emitted in any one of the eighth through tenth SFs, emitting is performed in the first through fourth SFs to a discharge cell that displays a gradation that has to be emitted in any one of the ninth and tenth SFs and emitting is performed in the first through fourth SFs to a discharge cell that displays a gradation that has to be emitted in the tenth SF is shown. When such a control is applied, the power of data electrode driving circuit 12 can be further reduced. Of course, when such a control is applied, consumption power reduction effect of data electrode driving circuit 12 becomes larger but the number of gradations that are used for display becomes scarce. When image display quality may be deteriorated owing to the deficiency of the number of gradations, an interpolation method such as an error diffusion method or the like is desirably used together to complement the number of gradations.

As mentioned above, in the embodiment of the invention, voltage Ve3 that is applied to the sustaining electrode in the writing period of the first SF is set high. Thereby, even in an isolated on-cell, the writing discharge can be assuredly caused and an off-cell is inhibited from occurring. In addition to this, when to a discharge cell that displays a gradation high in the brightness even in a sub-field whose brightness weight is small is controlled so as to emit, the fault on-cell can be suppressed from occurring and the power consumption of the data electrode driving circuit as well can be suppressed.

In the embodiment of the invention, voltage Ve3 that is applied to the sustaining electrode during the writing period of the sub-field whose display brightness is lowest is set high to make the writing discharge occur more easily. However, a method by which the writing discharge of the first SF can be occurred more easily is not restricted thereto. For instance, the writing pulse voltage of the first SF may be set higher than the writing pulse voltage of the other sub-fields or the scanning pulse voltage of the first SF may be set higher than the scanning pulse voltage of the other sub-fields.

Furthermore, in the embodiment of the invention, the brightness weight of each of the sub-fields is set so as not to be larger than the brightness weight of a sub-field that is disposed after the sub-field. However, in the invention, the number of the sub-fields and the brightness weights of the respective sub-fields are not restricted to foregoing one. Even in a case where one field is divided into, for instance, 12 sub-fields (first SF, second SF, . . . , twelfth SF) and one field is constituted of two or more sub-field groups whose brightness weight increase like that (1, 2, 4, 8, 16, 32, 56, 4, 12, 24, 40 and 56), the invention can be applied.

### INDUSTRIAL APPLICABILITY

The invention can provide a panel driving method that is difficult to cause an off-cell even when a low gradation is displayed and excellent in image display quality; accordingly, the invention is useful as a driving method of a plasma display panel and a plasma display device.

1. A driving method of a plasma display panel with a discharge cell at an intersection of a scanning electrode and a sustaining electrode with a data electrode, comprising:
with one field period constituted of a plurality of sub-fields with a writing period and a sustaining period,
selectively generating writing discharge in the discharge cell in the writing period,
generating sustaining discharge for letting a discharge cell where the writing discharge was caused emit light at a predetermined brightness weight in the sustaining period;
setting a voltage that is applied to the sustaining electrode in a writing period of a sub-field lowest in the brightness weight of the plurality of sub-fields to be higher than a voltage applied to the sustaining electrode in a writing period of sub-fields other than the above sub-field; and
comparing a first threshold value of a predetermined gradation and a gradation of each of the discharge cells to control when whether each of sub-fields emit or not emit light is controlled to display a predetermined gradation at the discharge cell so that a discharge cell that displays a gradation higher than the first threshold value emits even in a sub-field lowest in the brightness weight.

2. The driving method of a plasma display panel of claim 1, wherein a discharge cell that displays a gradation higher than a second threshold value being higher than the first threshold value is controlled so as to emit light even in sub-fields lowest and next to the lowest in the brightness weight.
